(19) United States
(12) Patent Application Publication
(10) Pub. No.: US 2004/0223614 A1
(43) Pub. Date: Nov. 11, 2004

(54) Secure video receiver

(76) Inventor: Philip Jeffrey Seaman, Los Gatos, CA (US)

Correspondence Address: PHILIP JEFFREY SEAMAN, 16130 JACARANDA WAY, LOS GATOS, CA, 95037-3608, US

(21) Appl. No.: 10/434,768

(22) Filed: May 8, 2003

(51) Int. Cl. H04N 7/167

(52) U.S. Cl. 380/239

(57) ABSTRACT

A secure means to provide video on demand to a user's TV set (1001) while preventing unauthorized viewing or copying is disclosed. Subsequent embodiments leverage off of the core elements to provide wireless phone, videophone, internet, email and storage capabilities.

### BACKGROUND OF INVENTION

Video on demand service is available; however, the cost is high and improvements are needed. To view video on demand, one needs a PC that is up to date as well as a high-speed internet connection. With this one can view video on demand from various internet websites.

This current video on demand solution has some problems. First the PC is not the optimal screen on which to watch a movie. PC screens are generally smaller, if not much smaller, than TV screens. Second, PCs are generally not located where people watch TV or Videos. TV sets are.

Third, even if a connection between a video on demand receiving PC and a TV set can be made, the displayed image is not optimal nor is the sound. If the image shows, it does not fill the screen. The sound is poor or garbled. Fourth, a PC is a very expensive. A PC is more expensive than a TV set and both are needed watch video on demand on a TV set. Fifth, a PC can copy video images and can run powerful enough software to overcome whatever protections the producers and distributors of those video images put into the video data stream. Producers of video content are concerned about delivering their product through a medium such as a PC that can so easily illegally copy and subsequently illegally re-distribute their product. Sixth the high speed digital line required is expensive.

So video on demand service is currently fraught with issues that need to be overcome.

The current, most highly used alternative to video on demand is rentals either most popularly via local stores or second most popularly via the mail. While low cost and displaying on a TV screen, these methods are inconvenient in the time required to execute the transaction. To wit, in the local store case, traveling to the store and back twice once to rent and once to return the video takes a number of minutes if not a significant fraction of an hour. Rentals by mail eliminate the customer need to do this; however, it takes at least a day to receive the rental.

The other means to deliver video, such as broadcast, cable or satellite, do not have the bandwidth to allow video on demand to a significant fraction of the served households. So at best they have resorted to pay-per-view allowing users to pay to watch first run videos that begin at set times during the day not at a random time at the users request.

Currently wired or wireless telephone service is not capable of providing video on demand. Neither is telephone service capability available via video rental services.

Currently high speed, two-way data access is most commonly available over either a telephone line via a DSL modem or over a coax cable TV line cable modem. Neither of these offers secure video to the users TV set without the use of a PC. They are also limited in the distance for the central office or head end particularly for DSL.

Video telephony is another technology that has not fulfilled it potential. While there are videophones that operate over telephone lines that use a special display, camera and telephone, the picture is not very good. This solution does not provide video on demand. The best current solution requires PC, a camera and a high-speed line. This solution provides a better image. However, like the video on demand solution, the requirement of a PC is an expensive requirement that limits the usefulness.

### SUMMARY OF INVENTION

It is the object of this invention to overcome the problems of the existing Video on Demand solutions.

First by having the device capable of delivering a video on demand feed to the input of a TV set the displayed image will be on a more optimal screen than that of a PC. This will also overcome the second problem of PC based video on demand by using the TV set that is where people typically watch videos.

By having suitable encryption on the video on demand signal so that it can only easily be de-encrypted by the receiving system as well placing copyright protections on the signal going to the TV set the image displayed with fill the whole TV screen and the sound will also be acceptable. By have a small dedicated device its cost will be less than that of a PC solving the fourth problem that of the high cost of a PC.

Further by having a small-dedicated device with no powerful generic processor or the device will keep the video secure solving the fifth problem. Producers of the video content will be assured that this means of distributing and displaying is no more subject to copying that any other distribution means.

By this means video can be more conveniently provided than by the most common alternate, video rental. There is no drive to the rental store and back to pick up the rental, no second trip to return the video, no wait for the postman to arrive with the rental from a mail order rental service. By using a wireless connection the high-speed link can cheaply, quickly and easily be set up. Hence the problems with video on demand can be overcome and it can be enjoyed by many more than currently are able to.

An additional embodiment is presented which also provides wireless phone capability in addition to video on demand of the first embodiment.

An alternate embodiment is presented that leverages off the high-speed data connection afforded by the first two embodiments. Significant capabilities are added, including one or more wireless modems and video transceivers including video telephony capability, as well as high-speed internet access point with a router, firewall, I/O ports, and a wireless network connectivity.

### BRIEF DESCRIPTION OF DRAWINGS

FIG. 1 Primary Embodiment Schematic

FIG. 2 Additional Embodiment Schematic

FIG. 3 Alternate Embodiment Schematic

### REFERENCE NUMERALS IN THE DRAWINGS

| | | | |
|---|---|---|---|
| 10 | Promary embodiment | 11 | Additional embodiment |
| 60 | Radio | 70a | Wireless Modem a |
| 70n | Wireless Modem n | 80a | Video Transceiver a |
| 80n | Video Transceiver n | 105 | Switch |
| 110 | Antenna | 111a | Antenna a |
| 111n | Antenna n | 120 | RF Transceiver |
| 130 | Baseband processor | 140 | MAC de/encryptor |
| 142 | MAC/Hardware interface | 143 | Location |
| 144 | Mux | 145 | Electronic Identification |
| | | | Number |
| 146 | De/Encryptor | 147 | router |
| 148 | Firewall | 149 | Hardware interface |
| 150 | Video decoder | 151 | Video codec |
| 152 | Processor | 153 | Mass storage |
| 154 | Telephone interface | 160 | Copyright protection |
| 180 | Input device | 230a | I/O a |
| 230n | I/O n | 1001 | TV Set |
| 1002 | Camera | 1003 | Telephone Line |
| 1004 | Server | 1005 | Telephone |
| 1006 | Server w | 1007 | PC w |
| 1008 | Printer | 1100 | Other devices |

### DETAILED DESCRIPTION

I. Introduction

Now referring to FIG. 1, there is a radio (60) comprising an antenna (110), RF transceiver (120), baseband processor (130), and Mac de/encryptor (140). The radio (60) changes a wireless encrypted video data stream into an unencrypted video data stream in the receive path while doing the reverse in the transmit direction.

A video decoder (150) decodes the unencrypted data stream into a standard video format that a TV set (1001) or monitor can display. Next copyright protection is added to the signal by the copyright protection (160) circuit. Now the copyright protected video is ready to be sent to the TV set (1001) or other display.

The device knows its location (143) and can provide it if requested. There is an electronic identification number (145) with which the device can be identified. There is a user input device (180) that allows the user to control the video content and otherwise provide inputs to the system. There is no data connection out of the device for the un-encrypted or un-copyright protected video. Thus a video on demand data stream can be received and displayed to a users TV set (1001) while preventing unauthorized copying or displaying.

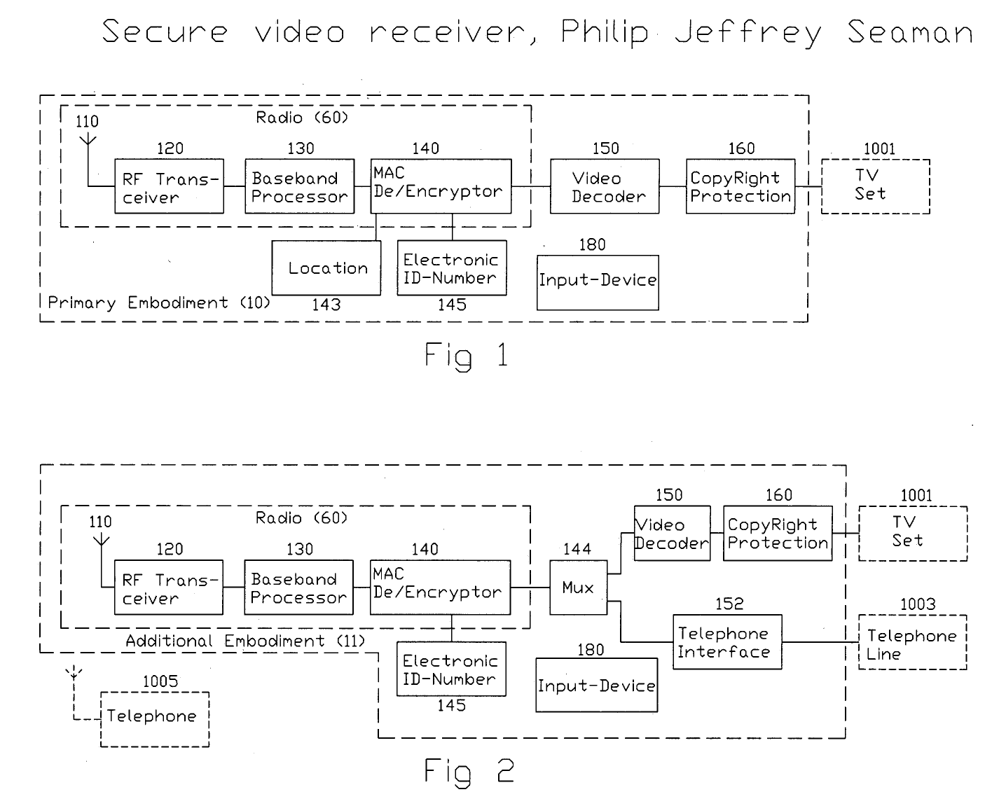

Now referring to FIG. 2 the additional embodiment schematic is shown. A telephone interface (153) and mux (144) have been added. By connecting to the user's telephone line (1003) the additional embodiment (11) can act as a base station for a wireless telephone (1005). The mux (144) appropriately directs data streams to and from the radio (60), the video decoder (150), and telephone interface (152).

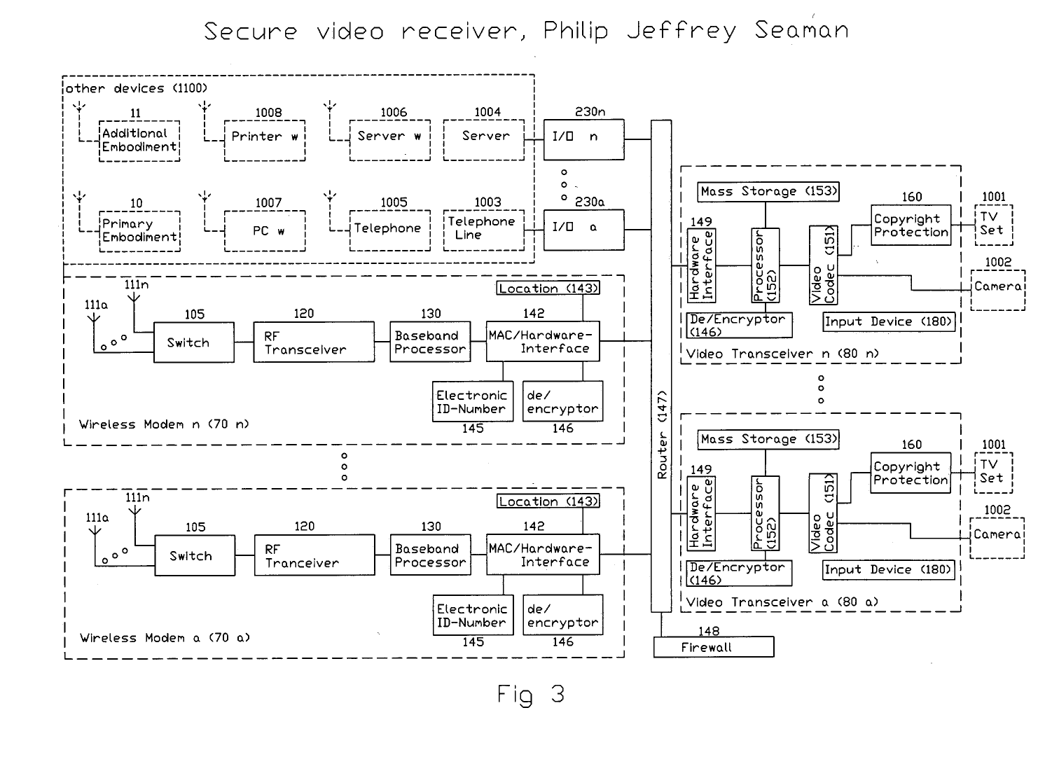

Now referring to FIG. 3, the alternate embodiment schematic is shown. The alternate embodiment provides expanded capabilities and the services including improved wireless capability as well as improved video with encryption capability, mass storage, two-way video, and high-speed data access point/router.

The improved wireless capability is comprised of one or more wireless modem (70a, 70n). A wireless modem (70a, 70n) is comprised of one more antenna (111a,111n), a switch (105), RF transceiver (120), baseband processor(130), and Mac/hardware interface (142), location (143), de/encryptor (146), and electronic identification number (145).

There is a switch (105) to connect the antennas (111a, 111n) to the RF transceiver (120). Having more than one antenna (111) improves the modem's (70) performance and hence increases the distance and data rate.

The improved video capability is comprised of one or more video transceiver (80a, 80n). There is a processor (152) that controls the elements of the video transceiver (80) including a hardware interface (149), video codec (151), de/encryptor (146), copyright protection (160), mass storage (153), electronic identification number (145), and input device (180).

In addition to the de/encryptor (146) in the wireless modem (70), there is also a de/encryptor (146) in the video transceiver (80). This allows encrypted video or data to be stored on the mass storage unit (153) and allows dual encryption. This improved video capability includes an electronic identification number (145) that allows unique identification of the video transceiver (80).

A video coder has been added to provide two-way video capability. The coder is combined with the decoder (150) of the primary embodiment to form a video coder-decoder or video codec (151). The video codec (151) can convert the signal from a camera into a coded video data stream.

This data stream can travel via the router (147) to the modem (70) which encrypts the data stream again to prevent unauthorized access and sends it out wirelessly.

Like the primary embodiment, there is an input device (180) that allows the user to input commands or responses. This can be used to dial another videophone user, play a video game, surf the internet or do other tasks. There is still no unencrypted video or standard video format connection in or out. Video received is as secure as in the primary embodiment. Video transmitted out is similarly secure.

The one or more wireless modems (70) and video transceivers (80) are connected to a router (147) that routes or switches the data between the modems (70), video transceivers (80) as well as to and from one or more I/O data ports (230a, 230n). There is a firewall (148) connected to the router (147) to prevent unauthorized access to the system.

The alternate embodiment improves the high-speed wireless capability and telephone capability of the prior embodiments. It also takes advantage of this high-speed link to provide high-speed internet access point functionality in addition to video on demand, videophone and video gaming capability.

II. Operation

To set up the primary embodiment (10), place the device on or near the TV (1001) or other display. Connect the device to the TV (1001) or other display.

To use, the device needs to log onto a network or other data source via the radio (60). The electronic identification number (145) and location (143) can help with this. If not previously or otherwise entered the location will need to be entered. Once logged on, the input device (180) is used to interact and select videos or other data to be displayed.

Set up of the additional embodiment (11) is similar to the primary embodiment (11) with the addition of connecting the telephone line (1003). As in the primary embodiment (10), the device needs to be connected wirelessly to a network or other source in order to interact and select videos or other data to be displayed.

Set up of the alternate embodiment is like the prior two embodiments, with the difference being that more TV sets (1001) or cameras (1002) as well as wireless modems (70) can be connected. If not directly connected one or more wireless modems (70) or video transceivers (80) may be connected to the router (147) via a cable. The input device (180) can be used to dial a call for video telephony.

Use is like the prior two embodiments (10, 11) for each individual wireless modem (70), video transceiver (80) or I/O port (230). The user logs on and then begins to watch videos or otherwise use the services made available by the device.

Another use of this device is web surfing or video game playing. With the user input device (180), such as a keyboard and mouse or a game joystick, the user can surf the web, send and receive emails or play video games either against the computer or against other users.

III. Conclusion

The primary embodiment disclosed provides more convenient video on demand service to a user's most common means of viewing video, their TV set (1001).

It is more convenient than video or DVD rentals either from local stores or shipment based sources since there is no trip to pick up the rental nor one to to return it. Neither is there a wait for the rental to arrive by mail. It is more convenient that PC based video on demand since it does not require an expensive PC and it displays on the users TV (1001). It is more convenient than pay per view since the user can choose when to watch rather than having to watch on a predetermined schedule. The video content is never readily available to be copied. Hence video content and other content providers can be at least as assured with this as with other distribution means.

A variety of encryption methods may be employed and be within the scope of this invention. For example any of the variants of data encryption standard may be used or triple data encryption standard as well as numerous key sizes for example 64, 128, 256 etc. Advanced encryption standard, public key infrastructure, and high bandwidth content protection and all of their variants could be employed. Many other encryption means can be employed and be within the scope of this invention.

Coding and de-coding of video is described. MPEG is a coding scheme that has the advantage of reducing the size of the required data stream, thus reducing the required minimum size of the data link. There are variants of MPEG that can be used that are within the scope of this invention such as MPEG-2, MPEG-3, MPEG-4 etc. Also there are other types of encoding that can be used and still be within the scope of this invention. A non-exhaustive list includes NTSC, PAL, SECAM, HDTV, SDTV, RGB, YcbCr, YpbPr, S-Video, CVBS, SDI, HDMI, and DVI. Further the two functions of encoding and compression may be separated. That is the information may be encoded by one means and compressed by another and still be within the scope of this invention.

The input device (180) could communicate by a variety of means including via RF, infrared or wire. The electronic identification number (145) could be hard wired, that is unchangeable. Alternatively it could be erasable or it could be a combination of the two, partially unchangeable partially changeable.

The electronic identification number could be 32 bits long to match up with the IPV4 address size. Alternatively, it could be 128 bits long and match up with the IPV6 address length. A benefit to a longer electronic identification number is that it increases the number of unique electronic identification numbers and thus minimize the likelihood of two devices having the same electronic identification number.

The location stored could be a street address for example 123 any street, apartment 4567, Anytown, Anystate, any postal code, Anycountry. It could be longitude and latitude coordinates. This information could be entered by the user. Alternatively, it could be determined by the network or the device itself by triangulating to the network and other end users whose location is known. Alternatively, it could also be determined by an on board global positioning system, also known as GPS or Glonass, Russia's similar system, or similar system. A key element is that the location be based in physical reality. This is as opposed to an address used in many protocols such as Ethernet which does not have a location associated with it. On the other hand the location (143) and electronic identification number (145) could be merged into one so that the electronic identification number (143) would be the location (145).

There are numerous benefits of having the device know its location (143). On initial startup it can help determine which base station is optimal to communicate with. Location (143) can help to uniquely identify the device for billing and antipiracy. As new devices and new base stations are put into place, having the devices know their location (143) would be helpful. If the device moves, for example across town, it would be helpful to know the accurate location (143). Similarly if the device was used for an emergency it would be helpful to be able to provide the location to emergency personal. Having the device know it's location can help in planning for the locations of new base stations.

In addition to securely receiving video, the device could securely receive music.

A wide variety of wireless frequencies and protocols may be employed. A non-exhaustive list includes all bands and protocols in the institute of electrical and electronics engineers 802 series of standards including 802.11 including 802.11a, 802.11b, 802.11g, 802.11h and 802.11i; 802.16, uNII, ISM, MDS, MMDS, HiperLAN, HiperLAN1, HiperLAN2, Euro-MMDS, High Speed Wireless Access in Japan, CDMA, wCDMA, GPRS, EDGE, PCS, WCS, GSM, UMTS and all of their variants. Other licensed and unlicensed frequency spectrum may be used and be within the scope of this invention.

Operation may cover just one frequency and protocol or may cover multiple countries' radio rules. For example the device may operate from 4.9 GHz to 5.85 GHz allowing operation in US using 802.11a or uNII; Japan using High Speed Wireless Access; or European using 802.11i or Hiperlan1 or Hiperlan2. Thus one design can be manufactured and be used in multiple countries, minimizing production, distribution, and support costs.

The radio is able to receive a video signal in real time. That is to be able to receive it as fast as it needs to be displayed. As better compression is used the radio data rate does not need to be as fast to do this. So as better compression techniques become available slower radios may be used.

The data rate may be spotty, that is not continuous, and still allow the device to display video on demand. For example if the radio can receive data at faster than the required rate a buffer of video data can be built up. If the radio loses the signal for a while, video can be viewed from the buffer with no disruption to the service. By monitoring the amount of buffer left the device can more or less urgently request more of the video to be sent.

To maximize the range and data rate all or part of the front end of the RF transceiver can be mounted outdoors and as far above ground a practical. This can include the LNA, PA & filter.

Because of this device a wide range of users will be able to more easily access video on demand. Further, this increased ease of access allows an expansion of the content variety. While ultimately the market will determine, the depth and breadth of the content will be wider and deeper than what is currently available. So in addition to movie rentals, television shows and other content may also be made available via this means.

For example a user could request to see last night's show that they missed. Like the video on demand example this device enables a more convenient solution than the alternatives. Currently one must have a TV recorder and direct it to record a show. While the disclosed additional embodiment has this capability, with the disclosed device the user can decide to watch a show after it has been broadcast. There is no need to remember to record the show prior to it being broadcast. This would be a benefit to the broadcasters as well since the user can be charged to view the show. Thus this can be another source of revenue for broadcasters, TV show producers and other producers and distributors of content. Hence this device can bring a new evolution in broadcast television. Because of the bandwidth available video content does not need to be sent to everyone at once. Rather it can be sent out as individually to as little as one user at a time when users request it. Further content may be developed specifically for this device, taking advantage of its features such as interactive shows where users interact with the content provider and with each other.

The telephone interface (152) of the additional embodiment (11) connects with one or more country's public switched telephone network, also known as PSTM. The device could be Internet protocol, also known as IP, Phone capable. That is phones (1004) without wireless IP call capability can use the device in either the primary (10), alternate (11) or additional embodiments to make a phone call. It would allow phone calls to be provided initially via the plain old telephone service line (1003). As network infrastructure becomes capable of handling phone calls these can be handled by the radio (60) rather than the phone line (1003). The radio (60) is capable of communicating over longer distances that the telephone (1003).

The alternate embodiment takes the wireless and video capabilities of the primary and additional embodiments and improves upon them. It also takes advantage of the high-speed wireless connection required for video on demand to provide a high speed wired access point and router (147) capability.

The alternate embodiment disclosed provides two-way video capability allowing video-telephony by the addition of an encoder (151), an encryptor (146), and a wireless modem (70) capable of sending as well as receiving video.

The device is an improvement on non-PC based videophones since the quality of the picture is better. It is an improvement on PC based solutions. Since its hardware is focused on video and transception only. There is no expensive, powerful, generic processing and storage capability. Consequently the disclosed device is lower cost while more secure and while still providing an excellent picture.

The alternate embodiment allows for services besides video on demand delivery including video gaming or internet surfing. With the high speed wireless link both of these services can be provided. With an input device such as a game joystick or keyboard and mouse, the user can provide inputs that can be sent back via the wireless link. Hence a user can play a video game, surf the internet, and write email using this device as the means to link to these services.

This capability may also be available with the primary (10) and additional (11) embodiments. It depends on the required back channel speed of the interactive content or application. Since the additional embodiment has the capability to transmit video most, if not all, interactive games or other application will be able to run on the additional (11) embodiment. While the primary embodiment (11) with its lower back channel requirement may not be able to handle as wide a range of interactive content and applications.

Another benefit of the video on demand capability is that a user could contact an operator to help in the event it is needed. This capability could also be used to verify the user's identity. For example the user could require visual identification before certain content is provided so that their child does not access inappropriate content.

As shown in FIG. 3 a wide variety of potential devices (1100) to communicate with including PC's (1007), printers (1008), servers (1004, 1006), the primary embodiment (10), the additional embodiment (11), telephones (1005), and telephone lines (1003) to name a few. The router (147) could route data around the in home telephone wiring (1003) via and I/O (230) and the customer's telephone line (1003)

The disclosed device compares favorably to other high-speed connections such as DSL or Cable Modems. These do not provide video on demand or videophone capability without an expensive PC. With an antenna with gain and the front end mounted outdoors, the radio can provide a link approaching five miles or more. DSL and to a lesser degree cable modems performance suffers when the user gets too far from the central office or head end. Also there are areas of the country where neither DSL nor cable modem data access is available. Setting up a wireless connection is quick and inexpensive relative to running a wire be it telephone or cable. Consequently this wireless device can more easily cover these areas.

The improved video capability includes mass storage (153) and encryption (146) that allows videos to be stored and stored. This provides the capability that VCRs and mass storage based recorders do not have, namely the ability to store encrypted video as well as the ability to provide video on demand and videophone service. The de/encryptor (146) does not need to be the same in each wireless modem (70) or video transceiver (80). For example the modem (70) could use advanced encryption standard and the video transceiver (80) could use data encryption standard. The mass storage device (153) can also be used as a telephone answering machine on which to store an outgoing message to callers as well as incoming messages from them.

Having an de/encryptor (146) in both the wireless modem(70) and video transceiver (80) enables dual encryption. This is when the video or data is encrypted twice. This makes unauthorized access to the video or data even more difficult. An unauthorized user will need to hack two encryptions not just one.

Having more than one wireless modem (70) allows faster wireless data rates by simultaneous operation. If two radios(70a, 70b) operate in a different frequency bands each can operate without jamming one another. For example the first radio (70a) operates between 2.3 GHz to 2.6 GHz while the second radio (70b) operates between 4.9 GHz and 5.85 GHz. Thus, one radio (70a) can be communicating at the same time the other (70b) without mutual interference. Hence the overall wireless data rate capacity is increased. This would also increase the number of wireless devices can be communicated with. Since with only one radio (70), say in the 5 GHz band, devices equipped with another type, say a 2.4 GHz radio, could not be communicated with and visa versa.

Another way to achieve a similar effect is by the use of directional antennas (111a, 111n). For example, one (111a) could be directed to the sender of the data and the other (111b) to where users will be. Thus two radios (70a, 70b) could both be communicating simultaneously.

A third way to prevent mutual interference is for the radios (70a, 70b) actual channel or frequency of use to be known. With this information each radio can use a specific channel or frequency that is not otherwise being used and hence mutual interference prevented.

The router (147) or switching function does not need to take place exactly where it is shown. It could take place from as early as in the wireless modem (70) or as late after copyright protection (160). For example the copy righted video output of the primary embodiment (60) could go into a router (147). The output of this could then be directed to a TV set (1001).

Arrangement of the elements does not have to be exactly as shown and still be within the scope of this invention. As shown in FIG. 3 the device may be used to supply video on demand to the primary embodiment (10) or additional embodiment (11). Thus not only has means to receive video on demand been described but also a means to supply the video on demand signal.

While described in individual embodiments, the various elements of each may be mixed and matched and still be within the scope of this invention. For example, video transceiver (80) or wireless modem (70) can be used in the primary embodiment (10) or a plurality of antennas (111) may be used in the primary embodiment (10) and still be within the scope of this invention. The video transceiver (80) does not need to have a codec (151) rather a decoder (150) or coder and camera (1002) or videophone capability. It could also be without the mass storage means (153) or de/encryptor (146). Dual encryption can be used in the primary (10) or additional (11) embodiments. The stored location (143) of the primary embodiment (10) could be used in the additional embodiment (11).

1. What is claimed is a secure video receiver comprising
(A) a radio capable of receiving a wireless encrypted video data stream and decrypting it into an unencrypted video data stream
(B) a video decoder means capable of translating said unencrypted video data stream into a standard video format
(C) a copyright protection means capable of copyright protecting said standard video format making it a copyright protected video
(D) an item selected from the group consisting of the device location storage means and a telephone line interface means
whereby video can be received and displayed without being copied.

2. In accordance with claim 1, further that there is no unprotected access to said unencrypted video data stream nor said standard video format
whereby neither may be readily copied.

3. In accordance with claim 1, further that the encrypted video data is encrypted via an encryption standard selected from the group consisting of data encryption standard and all its variants, triple data encryption standard and all its variants, advanced encryption standard and all its variants, public key infrastructure and all its variants, high bandwidth digital content protection and all its variants
whereby unauthorized access is prevented.

4. In accordance with claim 1, further that said secure video receiver is capable of receiving real time video
whereby video can be displayed at the same rate that it is received.

5. In accordance with claim 1, further that the radio's front end is located outside of the building
whereby the data rate and range is maximized.

6. In accordance with claim 1, further that said radio operates under the standard selected from the group consisting of 802.11, 802.11a, 802.11b, 802.11g, 802.11h, 802.11i, 802.16, uNII, ISM, MDS, MMDS, HiperLAN, HiperLAN1, HiperLAN2, Euro-MMDS, High Speed Wireless Access, CDMA, wCDMA, PCS, GPRS, EDGE, WCS, GSM, UMTS and all of their variants.

7. In accordance with claim 1, further that said standard video format is selected from the group consisting of NTSC, PAL, SECAM, HDTV, SDTV, RGB, YcbCr, YpbPr, S-Video, CVBS, SDI, HDMI, HDCP and all their variants whereby users can see the video on their existing TV set.

8. In accordance with claim 1, further that the video coding compresses the signal whereby the required link data rate can be lower.

9. In accordance with claim 1, further that the location is determined by an item selected from the list consisting of global positioning system and glosnass whereby the location can be automatically determined without user input and the location can be accurately known.

10. In accordance with claim 1, further that the said telephone interface means is capable of communicating with the public switched telephone network whereby wireless telephone calls can be made.

11. What is claimed is a secure wireless video transceiver, access point and router comprising
(A) one or more wireless modem comprising
(1) a radio capable of receiving and transmitting a wireless encrypted video data stream
(2) a de/encryption means by which the received encrypted video can be decrypted into received coded video and the user's coded video may be encrypted into encrypted video for transmitting whereby wireless links can be made with a variety of devices in a variety of areas
(B) one or more video transceiver comprising
(1) a video coder/decoder means by which said received coded video can by decoded into a standard video format and the user's video may be coded into said user's coded video
(2) a copyright protection means by which said received standard video format stream can be copyright protected whereby received video cannot be copied whereby video can be received and displayed without being copied and the user's video can be transmitted without unauthorized copying
(3) a location storage means
(C) a router to which said wireless modem and said video transceiver are connected so that data and video can be appropriately routed to and from each
whereby the wireless modems and video transceivers and wired ports can all communicate at high speed, and multiple TVs and cameras can be used.

12. In accordance with claim 11, further that one or more of said wireless modems have a plurality of antennas
whereby the link performance is improved.

13. In accordance with claim 11, further that one or more of said video transceiver has a mass storage device
whereby voice, video, and data content can be stored.

14. In accordance with claim 11, further that one or more of said wireless transceiver and video transceiver has an electronic serial number
whereby each can be uniquely addressed and identified preventing unauthorized access.

15. In accordance with claim 1 4, further that the electronic serial number has a length of 32 bits or more
whereby many devices can be uniquely addressed.

16. In accordance with claim 11, further that there is a firewall connected to the router that prevents unauthorized use of the device.

17. What is claimed is a method of secure video reception comprising
(A) receiving wireless encrypted video data stream with a radio
(B) decrypting the encrypted video data stream into unencrypted video data
(C) decoding said unencrypted video data into a standard video format
(D) copyright protecting said standard video format
(E) a process selected from the group consisting of storing the device location, and interfacing with a telephone line
whereby video can be received and displayed without being copied.

18. In accordance with claim 17, further where the method of encrypting and decrypting is selected from the group consisting of data encryption standard and all its variants, triple data encryption standard and all its variants, advanced encryption standard and all its variants, public key infrastructure and all its variants and high bandwidth digital content protection and all its variants.

19. In accordance with claim 17, further protecting the said unencrypted video data and said standard video format so there is no unauthorized access
whereby neither may be copied without authorization.

20. In accordance with claim 17, further locating the said radio's front end outside of the building
whereby the data rate and range is maximized.
